(19) United States
(12) Patent Application Publication
(10) Pub. No.: US 2024/0073988 A1
(43) Pub. Date: Feb. 29, 2024

(54) PROACTIVE GRANT ALLOCATION DURING A RADIO RESOURCE CONTROL (RRC) REESTABLISHMENT PROCEDURE

(71) Applicant: Radisys Corporation, Hillsboro, OR (US)

(72) Inventors: Rajendra Prasad Kodaypak, Sammamish, WA (US); Nalinikanta Dash, Puri (IN)

(21) Appl. No.: 17/821,397

(22) Filed: Aug. 22, 2022

(51) Int. Cl. H04W 76/27

(52) U.S. Cl. CPC H04W 76/27

(57) ABSTRACT

The disclosed techniques provide UL grant in a proactive manner by gNB or disaggregated RAN towards UE for transmission of RRC reestablishment complete message during RRC reestablishment procedure. Under current 3GPP specifications, there are no PUCCH resources available at UE to transmit SR for requesting UL grant to transmit RRC reestablishment complete. The UE must trigger again a RACH process for obtaining a UL grant for transmitting the RRC reestablishment complete message. This results in RAN inefficiency due to additional signaling and higher latency. The ability to transfer RRC signaling messages in DOCSIS transport environment is further impacted due to added latency. Allocating the UE with a proactive grant improves the RRC reestablishment procedure, as well reduces radio network latency in a DOCSIS transport network. This also resolves radio network impacts arising due to a second RACH attempt for sending the RRC reestablishment complete message.

### TECHNICAL FIELD

This application relates generally to wireless communication systems, and more specifically to techniques for reducing latency in 5G systems and those leveraging Data Over Cable Service Interface Specifications (DOCSIS) transport networks.

### BACKGROUND INFORMATION

Wireless mobile communication technology uses various standards and protocols to transmit data between a base station and a wireless mobile device. Wireless communication system standards and protocols can include the 3rd Generation Partnership Project (3GPP) long term evolution (LTE) (e.g., 4G) or new radio (NR) (e.g., 5G); the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi.

In 3GPP radio access networks (RANs) in LTE systems, the base station can include a RAN Node such as a Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE).

In fifth generation (5G) wireless RANs, RAN Nodes can include a 5G Node, NR node (also referred to as a next generation Node B or g Node B (gNB)).

RANs use a radio access technology (RAT) to communicate between the RAN Node and UE. RANs can include global system for mobile communications (GSM), enhanced data rates for GSM evolution (EDGE) RAN (GERAN), Universal Terrestrial Radio Access Network (UTRAN), and/or E-UTRAN, which provide access to communication services through a core network. Each of the RANs operates according to a specific 3GPP RAT. For example, the GERAN implements GSM and/or EDGE RAT, the UTRAN implements universal mobile telecommunication system (UMTS) RAT or other 3GPP RAT, the E-UTRAN implements LTE RAT, and NG-RAN implements 5G RAT. In certain deployments, the E-UTRAN may also implement 5G RAT.

Frequency bands for 5G NR may be separated into two different frequency ranges. Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1. Skilled persons will recognize these frequency ranges, which are provided by way of example, may change from time to time or from region to region.

The 3GPP technical specification (TS) 38.331 (TS 38.331) specifies the radio resource control (RRC) protocol used in 3GPP systems. The RRC protocol includes a RRC reestablishment features, the purpose of which is to reestablish an RRC connection after a temporary loss of the connection, e.g., when a mobile phone or other UE is transported through a road tunnel blocking a wireless signal.

A UE will trigger RRC reestablishment when access stratum (AS) security has been activated with signaling radio bearer two (SRB2) and at least one data radio bearer (DRB) being set up. A UE will also initiate the procedure to continue the RRC connection for integrated access and backhaul (IAB) SRB2. If the network is able to find a valid UE context, it will reestablish the RRC connection or else a fallback procedure will be initiated to establish new connection.

Cellular 5G standalone (SA) technology (defined per 3GPP Releases 15 and 16 standards), in conjunction with Open Radio Access Network (O-RAN) alliance driven radio access networking and its evolution, is expected to drive the adoption of software defined disaggregated mobility networking leveraging various modes of transport. Given a wide variety of architectural deployment options possible at the transport layer with the cloud native 5G access and core networks evolution, cable service providers could leverage their existing infrastructure or enhance it or switch to a new technology based on the 5G mobility requirements as well as differentiated services they plan to offer.

As 5G SA network architectures embrace O-RAN standards and adopt the use of disaggregated software defined radio access and core network functions, the mobile xhaul (where “x” may be fronthaul, midhaul, or backhaul) transport strategies become a consideration for E2E services delivery. Carriers with licensed or unlicensed low, mid, or high band spectrum availability intending to launch 5G mobile services based on SA network architecture designs should evaluate their backhaul scaling strategies to ensure they are capable of meeting latency demands placed by the emerging 5G applications.

### SUMMARY OF THE DISCLOSURE

Disclosed are embodiments for signaling a proactive grant in order to send an RRC reestablishment complete message. In some embodiments, a gNB will allocate the proactive grant through DCI 0_0 scrambled using cell-radio network temporary identifier (C-RNTI). The C-RNTI is allocated to a UE using common search space after contention resolution containing six-byte common control channel (CCCH) service data unit (SDU), which was transmitted as Msg3 and TC-RNTI promoted to C-RNTI at the UE. The UE monitors for the proactive grant scheduled via DCI 0_0 using newly promoted C-RNTI in common search space configured in SIB1. In the resource grant indicated via DCI 0_0, the UE can transmit the RRC reestablishment complete message.

This approach of proactive grant helps in eliminating a second RACH attempt requirement during RRC reestablishment, which solves resource wastage. It also reduces latency as the RRC reestablishment complete can be sent without any additional signaling and so the required latency defined for RRC reestablishment procedure is met. With proactive grant allocation, it is possible to see a 20-25% reduction in latency for overall RRC reestablishment procedure compared with using second RACH attempt for transmission of RRC reestablishment complete.

As DOCSIS standards continue to evolve and enhance the end user broadband connectivity model in a converged wireless and wireline networking environment, the ability to design and introduce cost-effective 5G mobility services with superior quality becomes extremely critical. Globally, Cable/MSOs can leverage their HFC outside plant infrastructure to drive high performance 5G ORAN enabled mobility services via software enhancements. This enables MSOs to expand their revenue models by offering 5G wireless services that could be leveraged across multiple industry verticals. There is significant network CapEx and OpEx savings to MSOs by leveraging their integrated Wireless and Wireline infrastructure resources for targeted 5G mobility residential and enterprise services introduction in locations where it adds business value. It drives continuous 5G and next generation mobility services evolution via leveraging HFC transport, security, and reliability enhancements with future spectrum licensing, licensed and unlicensed band allocations, geo-optimized traffic switching between cells based on end user mobility and applications. It provides an ability to support multiple digital endpoints such as wireless and wireline gateways and radio access technologies when leveraging HFC transport architecture.

The following are some advantages when the RRC reestablishment procedure is deployed using the techniques of this disclosure. RRC reestablishment procedure is used to reestablish the RRC connection if RRC link failure observed such as due to radio link failure (RLF), handover failure, reconfiguration failure, integrity failure, and the like. Accordingly, resuming RRC link during such failover conditions rapidly enhances end user connectivity experience without any service interruption. If RRC reestablishment procedure is triggered due to RLF, then link recovery will be substantially faster. During the handover procedure in 5G, due to any failure in source cell or target cell and if RRC reestablishment procedure is triggered, then the UE will successfully recover RRC connection with reduced latency which is a mandatory requirement for latency sensitive signaling flow. Using proactive grant allocation for transmission of RRC reestablishment complete by UE, an operator can remove contention issues that may arise due to multiple contention based random access procedure attempt during RRC reestablishment. In a high-capacity deployment scenario where there is a need to connect one CU with multiple DU's (M) and each DU supports multiple cell's (N), the above approach will help in reducing the number of signaling message exchanges required between gNB and UE. With the flexible deployment model for O-RAN wherein the DU and CU network functions can be in different data centers, they need to process the RRC signaling messages between UE and gNB over radio, fronthaul and mid haul interfaces. These exchanges need to be efficiently handled in both DL and UL for RRC reestablishment procedure during any anomalous radio condition.

Cable/Multi-Service Operators (MSOs) planning to deploy 5G networks using their existing hybrid fiber coax (HFC) outside plant infrastructure with the latest DOCSIS standards (DOCSIS 3.1) and its evolution (DOCSIS 4.0) as transport will benefit with the techniques of this disclosure. As they leverage DOCSIS transport over mobile xhaul (x=front/mid/back) interfaces between radio access and core network functions, as mentioned in below architecture options, the techniques of this disclosure will considerably improve end user service behaviors. Typically, the latency in DOCSIS-HFC networks could increase with capacity/traffic loading. Typical upstream latencies can vary anywhere from 8-12 msec to a maximum of 50 msec based on the traffic loading, users scheduling, and grant mechanisms.

Additional aspects and advantages will be apparent from the following detailed description of embodiments, which proceeds with reference to the accompanying drawings.

### BRIEF DESCRIPTION OF THE DRAWING FIGURES

To easily identify the discussion of any particular element or act, the most significant digit or digits in a reference number refer to the figure number in which that element is first introduced.

FIG. 1 is a block diagram of a wireless communications system, in accordance with one embodiment.

FIG. 2 is a set of block diagrams showing three example options for open radio access networks (O-RANs) utilizing a data over cable service interface specification (DOCSIS) transport network in, respectively, fronthaul, midhaul, and backhaul communication, in accordance with examples described herein.

FIG. 3 is a message sequence diagram for a conventional RRC reestablishment process, in accordance with one embodiment.

FIG. 4 is a message sequence diagram of an RRC reestablishment procedure including a proactive grant for transmitting an RRC reestablishment complete message, in accordance with examples described herein.

FIG. 5 is a message sequence diagram of the RRC reestablishment procedure of FIG. 4, performed by the O-RAN entities of FIG. 2.

FIG. 6 is a message sequence diagram of an RRC reestablishment procedure including a proactive grant for transmitting an RRC reestablishment complete message, in accordance with examples described herein.

FIG. 7 is a block diagram of computing components for performing the disclosed procedures, in accordance with one embodiment.

### DETAILED DESCRIPTION OF EMBODIMENTS

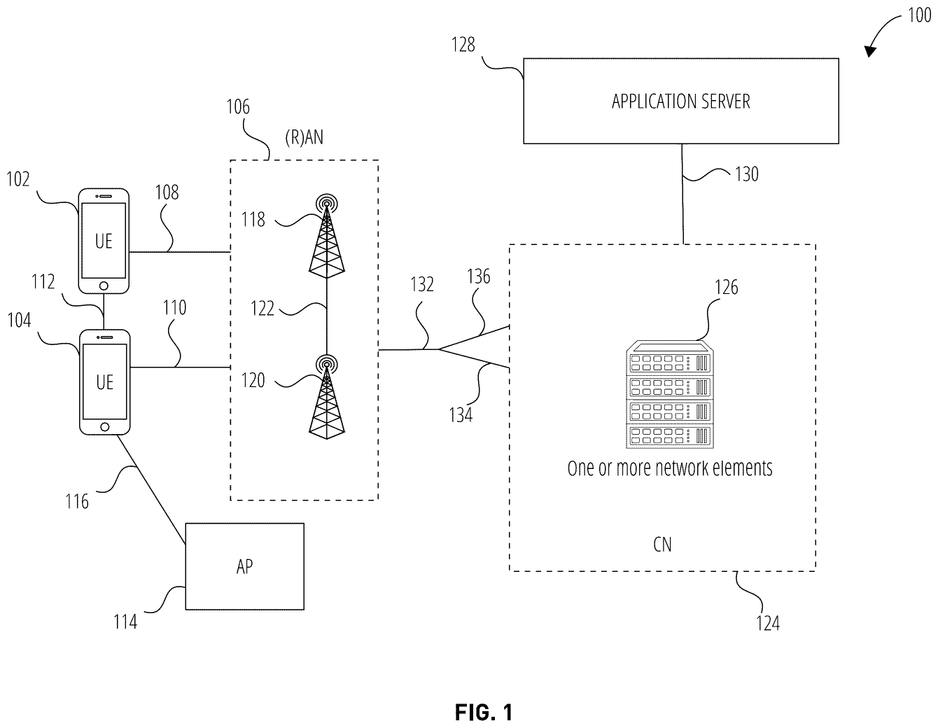

FIG. 1 illustrates an example architecture of a system 100 of a network, in accordance with various embodiments. The following description is provided for an example system 100 that operates in conjunction with the LTE system standards and 5G or NR system standards as provided by 3GPP technical specifications. However, the example embodiments are not limited in this regard and the described embodiments may apply to other networks that benefit from the principles described herein, such as future 3GPP systems (e.g., Sixth Generation (6G)) systems, IEEE 802.16 protocols (e.g., WMAN, WiMAX, etc.), or the like.

As shown by FIG. 1, system 100 includes UE 102 and UE 104. In this example, UE 102 and UE 104 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, MTC devices, M2M, IoT devices, and/or the like.

In some embodiments, UE 102 and/or UE 104 may be IoT UEs, which may comprise a network access layer designed for low power IoT applications utilizing short-lived UE connections. An IoT UE can utilize technologies such as M2M or MTC for exchanging data with an MTC server or device via a PLMN, ProSe or D2D communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

UE 102 and UE 104 may be configured to connect, for example, communicatively couple, with an access node or radio access node (shown as (R)AN 106). In embodiments, (R)AN 106 may be an NG RAN or a SG RAN, an E-UTRAN, or a legacy RAN, such as a UTRAN or GERAN. As used herein, the term “NG RAN” or the like may refer to a (R)AN 106 that operates in an NR or SG system, and the term “E-UTRAN” or the like may refer to a (R)AN 106 that operates in an LTE or 4G system. UE 102 and UE 104 utilize connections (or channels) (shown as connection 108 and connection 110, respectively), each of which comprises a physical communications interface or layer (discussed in further detail below).

In this example, connection 108 and connection 110 are air interfaces to enable communicative coupling, and can be consistent with cellular communications protocols, such as a GSM protocol, a CDMA network protocol, a PTT protocol, a POC protocol, a UMTS protocol, a 3GPP LTE protocol, a SG protocol, a NR protocol, and/or any of the other communications protocols discussed herein. In embodiments, UE 102 and UE 104 may directly exchange communication data via a ProSe interface 112. ProSe interface 112 may alternatively be referred to as a sidelink (SL) interface 110 and may comprise one or more logical channels, including but not limited to a PSCCH, a PSSCH, a PSDCH, and a PSBCH.

UE 104 is shown to be configured to access an AP 114 (also referred to as “WLAN node,” “WLAN,” “WLAN Termination,” “WT” or the like) via connection 116. Connection 116 can comprise a local wireless connection, such as a connection consistent with any IEEE 802.11 protocol, wherein the AP 114 would comprise a wireless fidelity (Wi-Fi®) router. In this example, AP 114 may be connected to the Internet without connecting to the core network of the wireless system (described in further detail below). In various embodiments, UE 104, (R)AN 106, and AP 114 may be configured to utilize LWA operation and/or LWIP operation. The LWA operation may involve UE 104 in RRC_CONNECTED being configured by RAN node 118 or RAN node 120 to utilize radio resources of LTE and WLAN. LWIP operation may involve UE 104 using WLAN radio resources (e.g., connection 116) via IPsec protocol tunneling to authenticate and encrypt packets (e.g., IP packets) sent over connection 116. IPsec tunneling may include encapsulating the entirety of original IP packets and adding a new packet header, thereby protecting the original header of the IP packets.

(R)AN 106 can include one or more AN nodes, such as RAN node 118 and RAN node 120, that enable the connection 108 and connection 110. As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to a RAN node that operates in an NR or SG system (for example, a gNB), and the term “E-UTRAN node” or the like may refer to a RAN node that operates in an LTE or 4G system 100 (e.g., an eNB). According to various embodiments, RAN node 118 or RAN node 120 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of RAN node 118 or RAN node 120 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by individual RAN nodes (e.g., RAN node 118 or RAN node 120); a MAC/PHY split wherein RRC, PDCP, RLC, and MAC layers are operated by the CRAN/vBBUP and the PHY layer is operated by individual RAN nodes (e.g., RAN node 118 or RAN node 120); or a “lower PHY” split wherein RRC, PDCP, RLC, MAC layers and upper portions of the PHY layer are operated by the CRAN/vBBUP and lower portions of the PHY layer are operated by individual RAN nodes. This virtualized framework allows the freed-up processor cores of the RAN node 118 or RAN node 120 to perform other virtualized applications. In some implementations, an individual RAN node may represent individual gNB-DUs that are connected to a gNB-CU via individual F1 interfaces (not shown by FIG. 1). In these implementations, the gNB-DUs may include one or more remote radio heads or RFEMs, and the gNB-CU may be operated by a server that is located in (R)AN 106 (not shown) or by a server pool in a similar manner as the CRAN/vBBUP. Additionally, or alternatively, one or more of RAN node 118 or RAN node 120 may be next generation eNBs (ng-eNBs), which are RAN nodes that provide E-UTRA user plane and control plane protocol terminations toward UE 102 and UE 104, and are connected to an SGC via an NG interface (discussed infra). In V2X scenarios one or more of RAN node 118 or RAN node 120 may be or act as RSUs.

The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink (UL) and downlink (DL) communication. The computing device(s) and some or all of the radio frequency circuitry of the RSU may be packaged in a weatherproof enclosure suitable for outdoor installation, and may include a network interface controller to provide a wired connection (e.g., Ethernet) to a traffic signal controller and/or a backhaul network.

RAN node 118 and/or RAN node 120 can terminate the air interface protocol and can be the first point of contact for UE 102 and UE 104. In some embodiments, RAN node 118 and/or RAN node 120 can fulfill various logical functions for (R)AN 106 including, but not limited to, radio network controller (RNC) functions such as radio bearer management, uplink and downlink dynamic radio resource management and data packet scheduling, and mobility management.

In embodiments, UE 102 and UE 104 can be configured to communicate using OFDM communication signals with each other or with RAN node 118 and/or RAN node 120 over a multicarrier communication channel in accordance with various communication techniques, such as, but not limited to, an OFDMA communication technique (e.g., for downlink communications) or a SC-FDMA communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from RAN node 118 and/or RAN node 120 to UE 102 and UE 104, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

According to various embodiments, UE 102 and UE 104 and RAN node 118 and/or RAN node 120 communicate data (for example, transmit and receive) over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHz, whereas the unlicensed spectrum may include the 5 GHz band.

To operate in the unlicensed spectrum, UE 102 and UE 104 and RAN node 118 or RAN node 120 may operate using LAA, eLAA, and/or feLAA mechanisms. In these implementations, UE 102 and UE 104 and RAN node 118 or RAN node 120 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

LBT is a mechanism whereby equipment (for example, UE 102 and UE 104, RAN node 118 or RAN node 120, etc.) senses a medium (for example, a channel or carrier frequency) and transmits when the medium is sensed to be idle (or when a specific channel in the medium is sensed to be unoccupied). The medium sensing operation may include CCA, which utilizes at least ED to determine the presence or absence of other signals on a channel in order to determine if a channel is occupied or clear. This LBT mechanism allows cellular/LAA networks to coexist with incumbent systems in the unlicensed spectrum and with other LAA networks. ED may include sensing RF energy across an intended transmission band for a period of time and comparing the sensed RF energy to a predefined or configured threshold.

Typically, the incumbent systems in the 5 GHz band are WLANs based on IEEE 802.11 technologies. WLAN employs a contention-based channel access mechanism, called CSMA/CA Here, when a WLAN node (e.g., a mobile station (MS) such as UE 102, AP 114, or the like) intends to transmit, the WLAN node may first perform CCA before transmission. Additionally, a backoff mechanism is used to avoid collisions in situations where more than one WLAN node senses the channel as idle and transmits at the same time. The backoff mechanism may be a counter that is drawn randomly within the CWS, which is increased exponentially upon the occurrence of collision and reset to a minimum value when the transmission succeeds. The LBT mechanism designed for LAA is somewhat similar to the CSMA/CA of WLAN. In some implementations, the LBT procedure for DL or UL transmission bursts including PDSCH or PUSCH transmissions, respectively, may have an LAA contention window that is variable in length between X and Y ECCA slots, where X and Y are minimum and maximum values for the CWSs for LAA. In one example, the minimum CWS for an LAA transmission may be 9 microseconds (μs); however, the size of the CWS and a MCOT (for example, a transmission burst) may be based on governmental regulatory requirements.

The LAA mechanisms are built upon CA technologies of LTE-Advanced systems. In CA, each aggregated carrier is referred to as a CC. A CC may have a bandwidth of 1.4, 3, 5, 10, 15 or 20 MHz and a maximum of five CCs can be aggregated, and therefore, a maximum aggregated bandwidth is 100 MHz. In FDD systems, the number of aggregated carriers can be different for DL and UL, where the number of UL CCs is equal to or lower than the number of DL component carriers. In some cases, individual CCs can have a different bandwidth than other CCs. In TDD systems, the number of CCs as well as the bandwidths of each CC is usually the same for DL and UL.

CA also comprises individual serving cells to provide individual CCs. The coverage of the serving cells may differ, for example, because CCs on different frequency bands will experience different pathloss. A primary service cell or PCell may provide a PCC for both UL and DL, and may handle RRC and NAS related activities. The other serving cells are referred to as SCells, and each SCell may provide an individual SCC for both UL and DL. The SCCs may be added and removed as required, while changing the PCC may require UE 102 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

The PDSCH carries user data and higher-layer signaling to UE 102 and UE 104. The PDCCH carries information about the transport format and resource allocations related to the PDSCH channel, among other things. It may also inform UE 102 and UE 104 about the transport format, resource allocation, and HARQ information related to the uplink shared channel. Typically, downlink scheduling (assigning control and shared channel resource blocks to UE 104 within a cell) may be performed at any of RAN node 118 or RAN node 120 based on channel quality information fed back from any of UE 102 and UE 104. The downlink resource assignment information may be sent on the PDCCH used for (e.g., assigned to) each of UE 102 and UE 104.

The PDCCH uses CCEs to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as REGs. Four Quadrature Phase Shift Keying (QPSK) symbols may be mapped to each REG. The PDCCH can be transmitted using one or more CCEs, depending on the size of the DCI and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an EPDCCH that uses PDSCH resources for control information transmission. The EPDCCH may be transmitted using one or more ECCEs. Similar to above, each ECCE may correspond to nine sets of four physical resource elements known as an EREGs. An ECCE may have other numbers of EREGs in some situations.

RAN node 118 or RAN node 120 may be configured to communicate with one another via interface 122. In embodiments where system 100 is an LTE system (e.g., when CN 124 is an EPC), interface 122 may be an X2 interface. The X2 interface may be defined between two or more RAN nodes (e.g., two or more eNBs and the like) that connect to an EPC, and/or between two eNBs connecting to the EPC. In some implementations, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a MeNB to an SeNB; information about successful in sequence delivery of PDCP PDUs to a UE 102 from an SeNB for user data; information of PDCP PDUs that were not delivered to a UE 102; information about a current minimum desired buffer size at the Se NB for transmitting to the UE user data; and the like. The X2-C may provide intra-LTE access mobility functionality, including context transfers from source to target eNBs, user plane transport control, etc.; load management functionality; as well as inter-cell interference coordination functionality.

In embodiments where system 100 is a SG or NR system (e.g., when CN 124 is an SGC), interface 122 may be an Xn interface. The Xn interface is defined between two or more RAN nodes (e.g., two or more gNBs and the like) that connect to SGC, between a RAN node 118 (e.g., a gNB) connecting to SGC and an eNB, and/or between two eNBs connecting to 5GC (e.g., CN 124). In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 102 in a connected mode (e.g., CM-CONNECTED) including functionality to manage the UE mobility for connected mode between one or more RAN node 118 or RAN node 120. The mobility support may include context transfer from an old (source) serving RAN node 118 to new (target) serving RAN node 120; and control of user plane tunnels between old (source) serving RAN node 118 to new (target) serving RAN node 120. A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on SCTP. The SCTP may be on top of an IP layer, and may provide the guaranteed delivery of application layer messages. In the transport IP layer, point-to-point transmission is used to deliver the signaling PDUs. In other implementations, the Xn-U protocol stack and/or the Xn-C protocol stack may be same or similar to the user plane and/or control plane protocol stack(s) shown and described herein.

(R)AN 106 is shown to be communicatively coupled to a core network-in this embodiment, CN 124. CN 124 may comprise one or more network elements 126, which are configured to offer various data and telecommunications services to customers/subscribers (e.g., users of UE 102 and UE 104) who are connected to CN 124 via (R)AN 106. The components of CN 124 may be implemented in one physical node or separate physical nodes including components to read and execute instructions from a machine-readable or computer-readable medium (e.g., a non-transitory machine-readable storage medium). In some embodiments, NFV may be utilized to virtualize any or all of the above-described network node functions via executable instructions stored in one or more computer-readable storage mediums (described in further detail below). A logical instantiation of CN 124 may be referred to as a network slice, and a logical instantiation of a portion of CN 124 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

Generally, an application server 128 may be an element offering applications that use IP bearer resources with the core network (e.g., UMTS PS domain, LTE PS data services, etc.). The application server 128 can also be configured to support one or more communication services (e.g., VoIP sessions, PTT sessions, group communication sessions, social networking services, etc.) for UE 102 and UE 104 via the EPC. Application server 128 may communicate with CN 124 through an IP communications interface 130.

In embodiments, CN 124 may be an SGC, and (R)AN 106 may be connected with CN 124 via an NG interface 132. In embodiments, NG interface 132 may be split into two parts, an NG user plane (NG-U) interface 134, which carries traffic data between RAN node 118 or RAN node 120 and a UPF, and S1 control plane (NG-C) interface 136, which is a signaling interface between RAN node 118 or RAN node 120 and AMFs.

In embodiments, CN 124 may be a SG CN, while in other embodiments, CN 124 may be an EPC). Where CN 124 is an EPC, (R)AN 106 may be connected with CN 124 via an S1 interface 132. In embodiments, S1 interface 132 may be split into two parts, an S1 user plane (S1-U) interface 134, which carries traffic data between RAN node 118 or RAN node 120 and S-GW, and S1-MME interface 136, which is a signaling interface between RAN node 118 or RAN node 120 and MMEs.

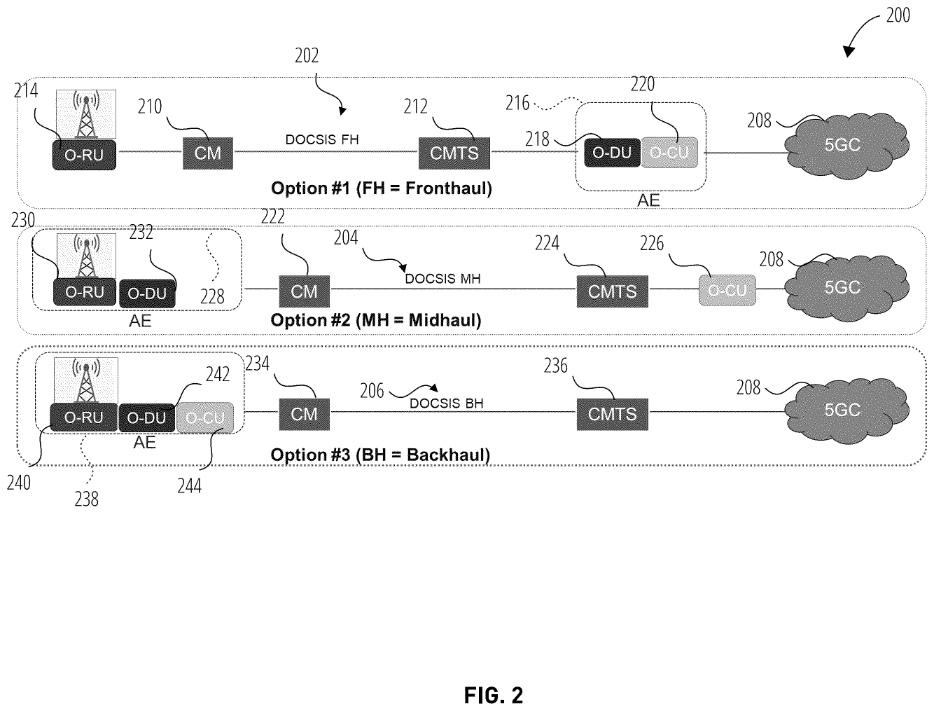

FIG. 2 shows three example options 200 for fronthaul 202, midhaul 204, and backhaul 206 DOCSIS transport networks configurations in O-RAN deployments providing communications to a 5GC 208, in accordance with examples described herein.

Each O-RAN includes an O-RAN radio unit (O-RU), an O-RAN distributed unit (O-DU), and an O-RAN central unit (O-CU). Each DOCSIS transport network includes a cable modem (CM) and a cable modem termination system (CMTS). For instance, in fronthaul 202 DOCSIS transport network, a CM 210 and a CMTS 212 are deployed between an O-RU 214 and an access element (AE) AE 216 that includes an O-DU 218 and an O-CU 220. In midhaul 204 DOCSIS transport network, a CM 222 and a CMTS 224 are deployed between an O-CU 226 and an AE 228 that includes an O-RU 230 and O-DU 232. In backhaul 206 DOCSIS transport network, a CM 234 and a CMTS 236 are deployed between 5GC 208 and an AE 238 that includes an O-RU 240, O-DU 242, and O-CU 244.

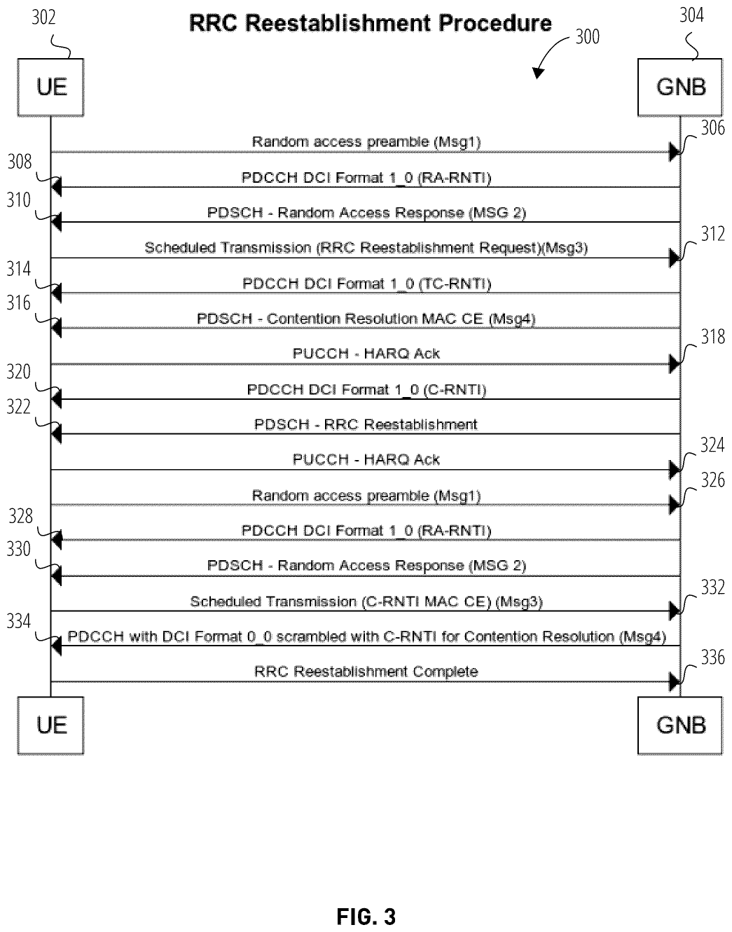

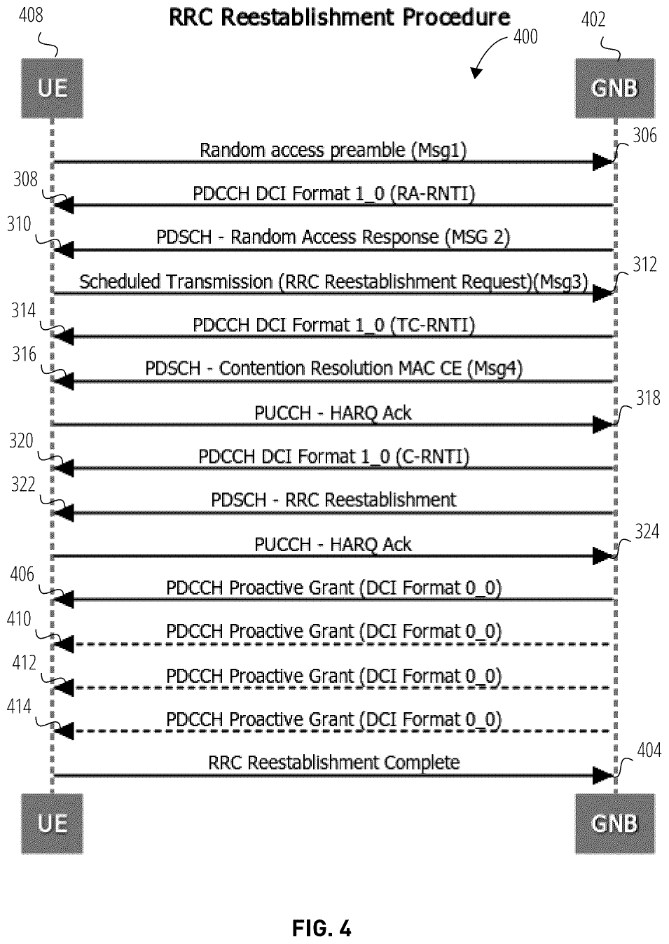

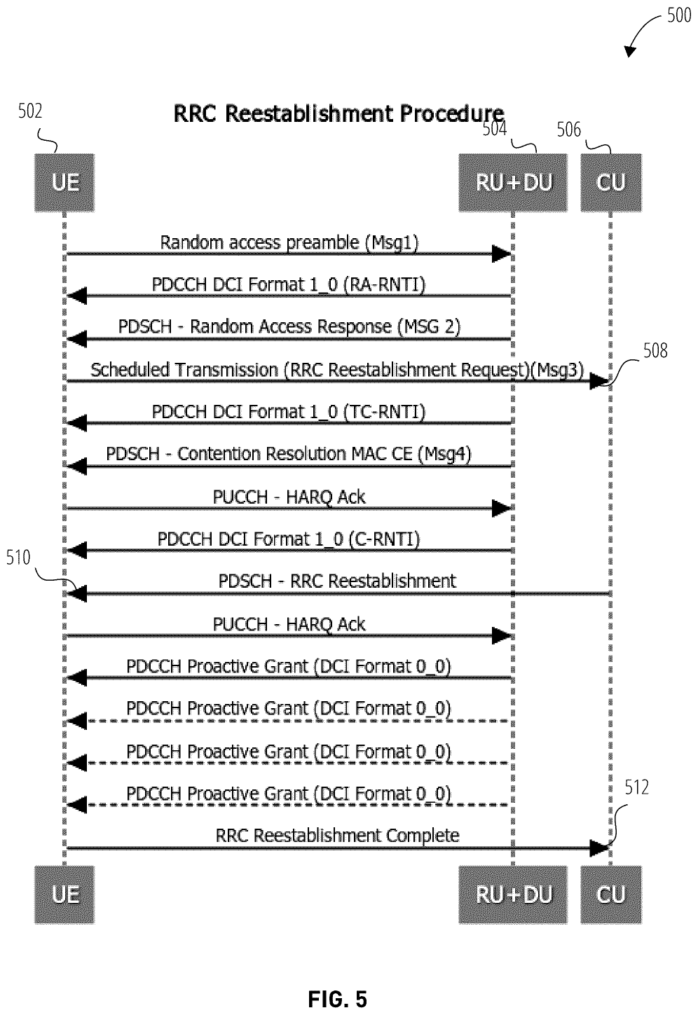

As DOCSIS transport network already adds additional latency in the communication path between radio access and 5GC 208, additional signaling (see e.g., RACH procedure of FIG. 3) by a UE for requesting grant to send an RRC reconfiguration complete message significantly increases latency. Thus, this disclosure describes allocating proactive grants (see e.g., FIG. 4 and FIG. 5) for sending the RRC reconfiguration complete messages during the RRC reestablishment procedure, which helps in reducing both signaling overload and latency over DOCSIS deployments while enhancing user experience.

Skilled persons will appreciate that, besides DOCSIS, other transport networks may also be implemented in options 200. For instance, a passive optical network (PON) or microwave transport network may be deployed for fronthaul, midhaul, or backhaul.

FIG. 3 shows a conventional RRC reestablishment procedure 300, according to the prior art. Initially, a UE 302 transmits to a gNB 304 a random access preamble (Msg1) 306, selected randomly from an available CB preamble.

Next, gNB 304 will allocate a random access response (RAR), in an RA-search space by scrambling PDCCH with random access-radio network temporary identifier (RA-RNTI) (i.e., PDCCH DCI format 1_0 (RA-RNTI) message 308), to transmit PDSCH random access response (Msg2) message 310 towards UE 302. In received RAR 310, UE 302 will receive time domain and frequency domain resource allocation for UL grant for scheduled transmission (RRC reestablishment request) (Msg3) message 312.

Once Msg3 312 is received by it, gNB 304 will send towards UE 302 temporary cell-RNTI (PDCCH DCI format 1_0 (TC-RNTI) message 314) and PDSCH contention resolution MAC CE (Msg4) message 316 containing logical channel ID (LCID) 62. Contention resolution will contain 6 octets of CCCH SDU transmitted by UE 302. UE 302 sends a PUCCH HARQ Ack 318.

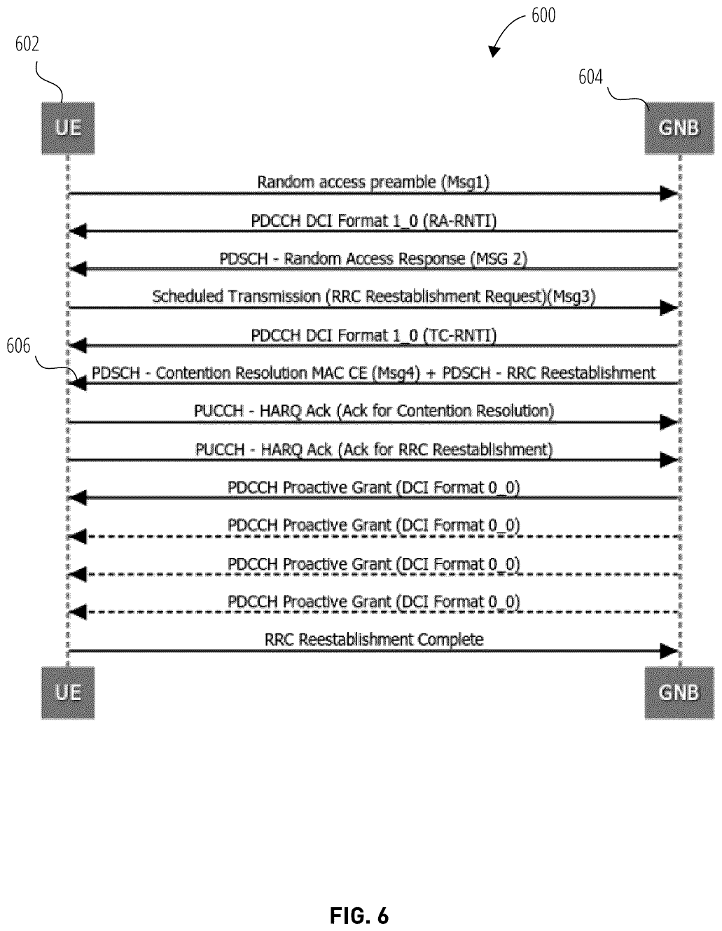

If UE 302 detects content of received MAC CE in Msg4 316 matches with content of the CCCH SDU that is transmitted, then UE 302 will consider contention as resolved. Next, gNB 304 will send response for received RRC reestablishment request 312 by sending PDCCH DCI format 1_0 (C-RNTI) message 320 and PDSCH RRC reestablishment message 322. In some embodiments (see e.g., FIG. 6), gNB 304 may schedule contention resolution MAC CE 316 and RRC reestablishment 322 towards UE 302 using single message.

Generally speaking, with reference to PDCCH DCI format 1_0 (TC-RNTI) message 314 and PDCCH DCI format 1_0 (C-RNTI) message 320, conventional RRC reestablishment procedure 300 is a three-way handshake. During the second step of the RACH procedure, gNB 304 allocates a C-RNTI which is temporary, i.e., temporary C-RNTI (TC-RNTI) 314. Then, if all four steps of the RACH procedure are successful, UE 302 will promote TC-RNTI 314 to C-RNTI 320 after contention resolution is successful.

Once the UE receives RRC reestablishment from the gNB, it sends PUCCH HARQ Ack 324. It will then need to transmit an RRC reestablishment complete message towards gNB 304. To do so, however, UE 302 needs to send an SR request towards the network using the PUCCH channel for allocating an UL grant. As explained below, this process is shown in the following repetitive signaling: random access preamble (Msg1) message 326, PDCCH DCI format 1_0 (RA-RNTI) message 328, PDSCH—random access response (Msg2) message 330, scheduled transmission (C-RNTI MAC CE) (Msg3) message 332, PDCCH DCI 0_0 addressed for contention resolution (Msg4) message 334, and RRC reestablishment complete message 336. In general, as there are no resources for transmitting an SR, UE 302 triggers RACH process again. In the second received RAR grant, UE 302 once again sends C-RNTI MAC CE towards gNB 304, and once the MAC CE is received at gNB 304 it again allocates PDCCH resources scrambled with indicated C-RNTI as Msg4. Once UE 302 able to decode received PDCCH containing DCI 0_0, UE 302 will consider contention as resolved. Using received PUSCH grant, UE 302 will transmit RRC reestablishment complete message 336 towards gNB 304.

In TS 38.331, before a UE transmits a RRC reestablishment request, it must perform steps defined in section 5.3.7 and resume SRB1. For resuming SRB1, the UE will use a default configuration defined in TS 38.331 section 9.2.1 for SRB1, which contains a default PDCP-Config and RLC-Config. As SRB1 is already resumed at the UE, the gNB does not include radioBearerConfig and masterCellGroup information elements (IEs) containing lower layer configuration for SRB1 within RRC reestablishment message being sent towards UE. The UE should send response for RRC reestablishment using RRC reestablishment complete. However, the UE does not have any PUSCH resources available for transmitting RRC reestablishment complete.

In case of all other RRC procedure, a UE triggers SR using configured PUCCH resources within SchedulingRequestResourceConfig configured within spCellConfig. As the UE has already released spCellConfig, it does not have any PUCCH resources for transmitting SR for sending RRC reestablishment complete. Before triggering the RRC reestablishment procedure, the UE releases spCellConfig within which PUCCH resources are configured for transmitting an SR.

A PUCCH resource configured within SIB1 IE PUCCH-ResourceCommon is available with UE during RRC reestablishment. As per TS 38.213 section 9.2.1, however, these PUCCH resource can only be used for transmission of HARQ. There is no mention in TS 38.213 for transmission of an SR using PUCCH-ResourceCommon. SIB1 provides cell specific resources to UEs registered in the cell. If all the UEs use same resource to transmit SR, it may lead to additional issue at the GNB such as CRC corruption at the physical layer, contention issue for PUCCH channel without any way to resolve, etc. So common PUCCH resources configured in SIB1 IE PUCCH-ResourceCommon cannot be used for transmission of SRs.

As the UE already released all configured PUCCH resources before transmitting an RRC reestablishment request, and the network does not allocate any PUCCH resources within the RRC reestablishment message towards the UE, the UE does not have any PUCCH resource for transmitting the SR towards the gNB. And as there is no PUCCH resources available at UE to transmit SR, the UE triggers the contention-based RACH procedure again to obtain resources for transmitting the RRC reestablishment complete message. RACH procedure must be triggered two times to complete RRC reestablishment procedure, as described above with reference to FIG. 3.

In current approach there are in total two times that a RACH process needs to be triggered for RRC reestablishment procedure to be concluded. This approach has following three drawbacks if deployed by operators.

First, for the transmission of RRC reestablishment complete again RACH process will add additional signaling overhead in both UL and DL. As air interface resources have limited bandwidth so any additional signaling will result in resource wastage for operator and possible revenue loss.

Second, if a UE is at cell edge while triggering preamble transmission during the second RACH attempt there may possibly a scenario arises where the preamble will not be reached at the gNB, and addition power ramp up needs to be applied for retransmission of RACH preamble again. These multiple attempts of preamble transmission will add additional latency in recovering radio link and exact latency will depend on the cell configured RACH configuration.

Third, as RACH procedure is contention-based, in a cell overload scenario there may contention occur during second RACH attempt resulting in RACH failure. So, UE needs to retry RACH process for sending RRC reestablishment complete towards network. This will add addition latency as well as signaling over air interface for completion of RRC reestablishment procedure may result in poor user experience.

FIG. 4 shows proactive grant RRC reestablishment procedure 400, which generally follows conventional RRC reestablishment procedure 300 of FIG. 3 until PDSCH RRC reestablishment message 322 is sent from a gNB 402. To send an RRC reestablishment complete message 404, gNB 402 allocates a proactive grant in PDCCH proactive grant (DCI 0_0) 406, i.e., there is no SR required from UE 302 by GNB 304 to allocate an UL grant for RRC reestablishment complete message 404.

For instance, in FIG. 4, after PDSCH contention resolution MAC CE (Msg4) message 316 is received and successful at UE 408 and TC-RNTI is promoted to C-RNTI, gNB 402 will allocate the proactive grant using DCI 0_0 scrambled using C-RNTI that is allocated to UE 408 using a common search space. The common search space is the space where gNB 402 allocates common information such as paging, system information, random access grant, etc. The common search space is configured at the cell level and remains same across all the UEs registered in that cell. Thus, details of the common search space information are already available at UE 408. UE 408 is allocated the common search space within servingCellConfigCommon of SIB1, which is available at UE 408 during proactive grant RRC reestablishment procedure 400. The pertinent information elements are nested within servingCellConfigCommon, as follows: servingCellConfigCommon>downlinkConfigCommon>>initialDownlinkBWP>>>pdcch-ConfigCommon.

UE 408 monitors the common channel (e.g., PDCCH) for a proactive grant using newly promoted C-RNTI in the common search space. Thus, the grant will be allocated using DCI format 0_0 within the PDCCH channel. As the DCI scrambled with C-RNTI is same as the C-RNTI uniquely allocated to each UE (i.e., UE 408 has its own C-RNTI), UE 408 will be able to know that grant 406 is allocated for it. Once UE 408 decodes the DCI, it will come to know which resource it need to use to transmit RRC reestablishment complete message 404. After determining the transmission recourse from received DCI 0_0 grant 406, UE 408 transmits RRC reestablishment complete message 404.

In some embodiments, PDCCH proactive grant (DCI 0_0) 406 contains following fields.

| Field | Size in Bit | Description |
|---|---|---|
| Identifier for DCI formats | 1 | Identified if the DCI is for downlink or |
| | | uplink |
| Frequency domain resource | Flexible bit size | This field used by gNB to indicate |
| assignment | | frequency domain resource allocation |
| | | towards UE in a resource grid. The unit |
| | | of allocation is in Physical Resource |
| | | Block (PRB). The size of this field is |
| | | determined based on BWP size as below- |
| | | $\vert {log}_{2} ( {N}_{RB}^{UL , BWP} ( {N}_{RB}^{UL , BWP} + 1 ) / 2 )$ |
| Time domain resource | 4 | This field used by gNB to point |
| assignment | | towards an index in a look up table for |
| | | time domain resource allocation in a |
| | | resource grid. Look up table is |
| | | configured in RRC signaling. The unit |
| | | of allocation is in Symbol, Slot, |
| | | Subframe, Frame. |
| Frequency Hopping Flag | 1 | Indicates if frequency hopping enabled |
| | | or not. If frequency hopping is enabled |
| | | then 1 or 2 MSB bit of frequency |
| | | domain resource allocation depending |
| | | on no of frequency offsets configured, |
| | | will be used to indicate frequency |
| | | hopping offset. |
| Modulation and coding | 5 | It points to an index in a look up table |
| scheme | | indicating what type of modulation and |
| | | coding scheme to be used such as |
| | | QPSK, 16QAM, 64QAM, 256QAM, |
| | | 1024 QAM. |
| New data indicator | 1 | This field indicated if this allocated |
| | | resource is for new transmission or |
| | | retransmissions. |
| Redundancy version | 2 | This indicated puncturing pattern to be |
| | | used after channel coding to match |
| | | allocated resources. |
| HARQ process number | 4 | Indicates HARQ process number. |
| | | There is maximum 16 HARQ process |
| | | per cell per UE. |
| TPC command for scheduled | 2 | This parameter is used for closed loop |
| PUSCH | | power control. |
| UL/SUL indicator | 0 or 1 | Indicates if the allocated UL resources |
| | | for normal uplink or supplementary |
| | | uplink. If size is 0 bit: this field can be |
| | | omitted else size would be of 1 bit. |
| Padding Bit | Flexible bit size | Padding is added to match the size of |
| | | DCI 0_0 with DCI 1_0 so that UE will |
| | | require lesser blind decoding attempts. |

If, due to any reason, UE 408 does send RRC reestablishment complete message 404 using the grant allocated in PDCCH proactive grant (DCI 0_0) 406, then gNB 402 have a failsafe mechanism to allocate grant once again, as shown in any one of optional sequential grants 410, 412, and 414. For example, in a poor radio condition at UE 408 (i.e., a cell edge scenario), UE 408 may not be able to decode received PDCCH containing DCI information sent by gNB 402 due to CRC corruption at physical layer. Then, gNB 402 may resend PDCCH proactive grant (DCI 0_0) 410 during a next transmission time interval (TTI). A sequence of additional PDCCH proactive grant (DCI 0_0) 412 and 414 may also be sent during subsequent TTIs.

In some embodiments the number of retransmissions of proactive grant 410, 412, and 414 is configurable. For example, gNB 402 may determine the number based on factors such as duplex configurations (i.e., FDD or TDD), slot format used in case of TDD system (e.g., in case of a DL-heavy slot format, there will be limited number of UL slots, hence there would be fewer proactive grant allocated for UL transmission), type of transport network deployed (e.g., DOCSIS, PON, microwave, or the like) to meet the latency requirement.

Eventually, if the failsafe mechanism result in no proactive grant at UE 408, it may elect to send an SR (as described in conventional RRC reestablishment procedure 300) after a configurable number of TTIs.

In a disaggregated O-RAN architecture (see e.g., FIG. 2), a MAC scheduler in a DU network function would allocate proactive grants to UE 408 to send RRC reestablishment complete message 404. For example, FIG. 5 shows another embodiment of a proactive grant RRC reestablishment procedure 500, similar to procedure 400, but in an O-RAN environment with a UE 502 in communication with an RU and DU 504 (see e.g., AE 228, FIG. 2) and disaggregated CU 506. This example is suitable for a DOCSIS transport in midhaul 204 (FIG. 2), in which CM 222 and CMTS 224 facilitate the following signaling with CU 506: a scheduled transmission (RRC reestablishment request) (Msg3) 508, PDSCH RRC reestablishment 510, and RRC reestablishment complete message 512.

FIG. 6 shows another proactive grant RRC reestablishment procedure 600 between a UE 602 and a gNB 604. As mentioned previously, gNB 604 may schedule is a single message 606 contention resolution MAC CE and RRC reestablishment towards UE 602. This results in two HARQ Acks from UE 602, and the proactive grant procedure is similar to that described previously with reference to FIG. 4. Also, skilled persons will appreciate that an O-RAN implementation (not shown) may be used for gNB 604, similar to that described with reference to FIG. 5.

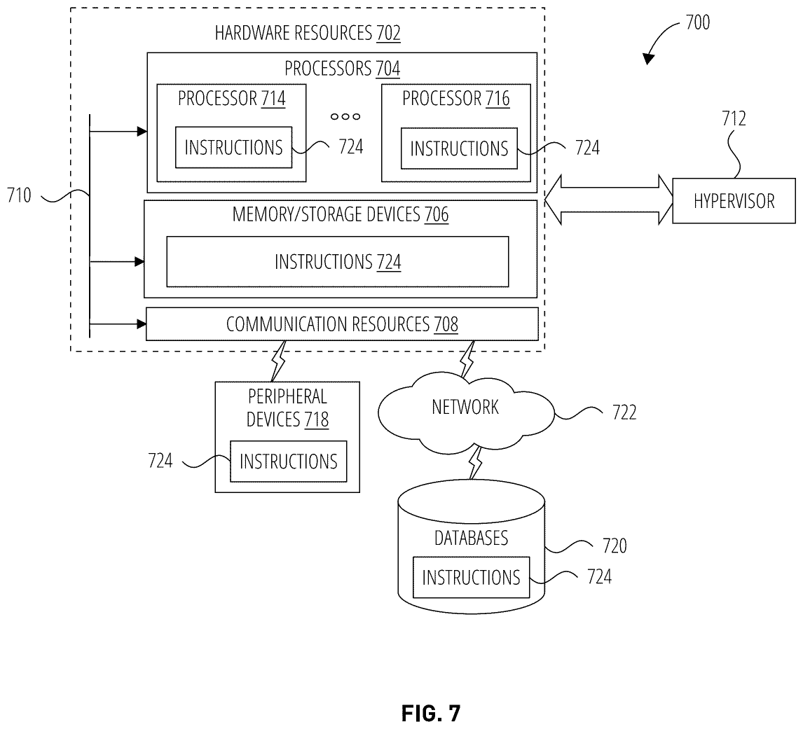

FIG. 7 is a block diagram illustrating components 700, according to some example embodiments, able to read instructions from a machine-readable or computer-readable medium (e.g., a non-transitory machine-readable storage medium) and perform any one or more of the methods discussed herein. Specifically, FIG. 7 shows a diagrammatic representation of hardware resources 702 including one or more processors 704 (or processor cores), one or more memory/storage devices 706, and one or more communication resources 708, each of which may be communicatively coupled via a bus 710. For embodiments where node virtualization (e.g., NFV) is utilized, a hypervisor 712 may be executed to provide an execution environment for one or more network slices/sub-slices to utilize hardware resources 702.

Processors 704 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 714 and a processor 716.

Memory/storage devices 706 may include main memory, disk storage, or any suitable combination thereof. Memory/storage devices 706 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

Communication resources 708 may include interconnection or network interface components or other suitable devices to communicate with one or more peripheral devices 718 or one or more databases 720 via a network 722. For example, communication resources 708 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 724 may comprise software, a program, an application, an applet, an app, or other executable code for causing at least any of processors 704 to perform any one or more of the methods discussed herein. Instructions 724 may reside, completely or partially, within at least one of processors 704 (e.g., within the processor's cache memory), memory/storage devices 706, or any suitable combination thereof. Furthermore, any portion of instructions 724 may be transferred to hardware resources 702 from any combination of peripheral devices 718 or databases 720. Accordingly, the memory of processors 704, memory/storage devices 706, peripheral devices 718, and databases 720 are examples of computer-readable and machine-readable media.

In light of this disclosure, skilled persons will appreciate that many changes may be made to the details of the above-described embodiments without departing from the underlying principles of the invention. The scope of the present invention should, therefore, be determined only by claims and equivalents.

What is claimed is:

1. A method, performed by a UE, of RRC reestablishment, the method comprising:
monitoring a common search space for a PDCCH DCI format 0_0 message indicating a proactive grant UL resource for transmitting an RRC reestablishment complete message;
decoding the PDCCH DCI format 0_0 message based on C-RNTI allocated to the UE to determine the proactive grant UL resource; and
transmitting the RRC reestablishment complete message in the proactive grant UL resource.

2. The method of claim 1, further comprising receiving an allocation for the common search space in a servingCellConfigCommon information element of a SIB1.

3. The method of claim 1, in which the monitoring includes receiving the PDCCH DCI format 0_0 message from a disaggregated RAN.

4. The method of claim 3, in which the disaggregated RAN includes an access entity (AE), an O-CU, and a transport network between the access entity and the O-CU, the AE including an O-RU and O-DU.

5. The method of claim 4, in which the transmitting causes the AE to forward the RRC reestablishment complete message through the transport network to the O-CU.

6. The method of claim 4, further comprising receiving a PDSCH RRC reestablishment message provided from the O-CU.

7. The method of claim 1, in which the monitoring includes receiving the PDCCH DCI format 0_0 message from a gNB.

8. The method of claim 1, in which the PDCCH DCI format 0_0 message is a second PDCCH DCI format 0_0 message received during a second transmission time interval (TTI) that follows a first TTI after a first PDCCH DCI format 0_0 message cannot be received or decoded.

9. The method of claim 1, further comprising transmitting a RACH request for requesting UL grant in response to no proactive grant being provided after multiple transmission time intervals (TTIs).

10. The method of claim 1, in which time and frequency domain resources for the proactive grant are indicated in separate fields of the PDCCH DCI format 0_0 message.

11. A method, performed by a RAN, of RRC reestablishment for a UE, the method comprising:
coding a PDCCH DCI format 0_0 message based on C-RNTI allocated to the UE to indicate a proactive grant UL resource for transmitting an RRC reestablishment complete message;
transmitting, in a common search space allocated to the UE, the PDCCH DCI format 0_0 message indicating the proactive grant UL resource; and
in response to the UE receiving and decoding the PDCCH DCI format 0_0 message, receiving the RRC reestablishment complete message in the proactive grant UL resource.

12. The method of claim 11, further comprising retransmitting the PDCCH DCI format 0_0 message in a sequence of transmission time intervals (TTIs).

13. The method of claim 11, further comprising transmitting an allocation for the common search space in a servingCellConfigCommon information element of a SIB1

14. The method of claim 11, in which the RAN comprises a gNB.

15. The method of claim 11, in which the RAN comprises a disaggregated RAN.

16. The method of claim 15, in which the disaggregated RAN includes an access entity (AE), an O-CU, and a transport network between the access entity and the O-CU, the AE including an O-RU and O-DU.

17. The method of claim 16, in which the receiving further comprises forwarding from the AE the RRC reestablishment complete message through the transport network to the O-CU.

18. The method of claim 16, further comprising transmitting a PDSCH RRC reestablishment message provided from the O-CU.

19. The method of claim 11, in which the transmitting comprising transmitting the PDCCH DCI format 0_0 message from a gNB.

20. The method of claim 11, further comprising determining a number of retransmissions of proactive grant based on at least one of duplex configuration, slot format, or type of transport network deployed.
